(19) United States
(12) Patent Application Publication
(10) Pub. No.: US 2007/0146753 A1
(43) Pub. Date: Jun. 28, 2007

(54) IMAGE PROCESSING APPARATUS AND TABLE CREATION METHOD

(75) Inventor: Hiromitsu Nishikawa, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/616,613

(22) Filed: Dec. 27, 2006

(30) Foreign Application Priority Data
Dec. 28, 2005 (JP) 2005-380065

(51) Int. Cl. H04N 1/60

(52) U.S. Cl. 358/1.9

(57) ABSTRACT

In creation of a conversion table such as a color separation table, probability of a false contour can be reduced and the load or time required for an interpolation calculation is reduced. Specifically, when a LUT is created, a cube constituting the LUT is firstly divided into two triangular prisms. Then, in each of the triangular prisms, triangles at the surface and inner triangles in parallel with the upper surface and the bottom surface are defined. Then, the respective triangles are assumed as interpolation spaces and lattice point data for lattice points in the triangles is determined. By this, only one boundary surface is caused when interpolation spaces are formed from the cube. Thus, probability where the lattice point data may be discontinuous at this boundary surface can be reduced. Thus, probability where a printed image may include a false contour can be reduced.

### BACKGROUND OF THE INVENTION

1. Field of the Invention

The present invention relates to an image processing apparatus and a table creation method. In particular, the present invention relates to how to define an interpolation space when lattice point data of a table is determined by interpolation.

2. Description of the Related Art

Typical tables used for an image processing include, for example, a color separation table for converting signal values of R, G, and B color spaces to signal values of ink as color material for a printer and a color conversion table for adjusting color gamut between an input device and an output device. These tables are generally formed as a lookup table (LUT).

The table as described above has been conventionally created by an illustrative example (Japanese Patent Application Laid-open No. 2002-033930) for example in which a color separation table is created in the manner as described below. First, on a cube composed of lattice points defined in a RGB space, six control lines connecting a white (W) lattice point, lattice points respectively corresponding to primary colors (C, M, Y) and secondary colors (R, B, G) of color materials of a printer, and black (Bk) lattice points are defined. In addition, a control line connecting the white lattice point and the black lattice point is defined. Then, with regards to the defined control lines, data for lattice points on these lines are determined and the determined data for these lattice points (e.g., C, Lc, M, Lm, Y, Bk) is used to determine data for other lattice points by an interpolation calculation.

According to the interpolation method disclosed by Japanese Patent Application Laid-open No. 2002-033930, a cube is firstly divided, as shown in FIGS. 9A to 9F, to six tetrahedrons having the above seven control lines as the respective sides. Then, four triangles at the surface of each of the tetrahedrons are assumed as an interpolation space in which lattice points are subjected to an interpolation by using the data of lattice points on the sides of the triangle, thereby determining lattice point data. Then, with regards to the interior of the tetrahedron, a triangle parallel to one triangle constituting the tetrahedron is taken with an interval of lattice points. Thus taken respective triangles are similarly assumed as an interpolation space so that data for lattice points in this interpolation space are determined.

However, the above-described conventional table creation method divides a cube into six tetrahedrons in order to define interpolation spaces. This causes, when a cube is divided, a relatively large number of triangles as boundary surfaces (i.e., common surfaces of respective two tetrahedrons, which are caused when the respective tetrahedrons are joined to constitute an original cube (hereinafter common surfaces formed by such a division are called as “dividing surfaces”)). For example, the tetrahedron shown in FIG. 9A has two dividing surfaces of a triangle WRBk and a triangle WMBk. Since each of these triangles and a triangle of other tetrahedron overlap each other, six tetrahedrons shown in FIGS. 9A to 9F have the total of twelve dividing surfaces.

The dividing surface as described above constitutes a boundary between different interpolation spaces. Thus, there may be a case where a finally created table includes discontinuity of lattice point data at this boundary surface. The discontinuous pieces of lattice point data as described above may cause, in the case of a color separation table for example, an image formed by color materials based on these pieces of lattice point data to have a false contour. The table as disclosed in Japanese Patent Application Laid-open No. 2002-033930 using six tetrahedrons as an interpolation space has a relatively great number of dividing surfaces, which causes a problem of a proportionally increased probability of the false contour. As described above, the existence of a great number of dividing surfaces causes in a table, when an image is formed based on the image processing result using the table, the image to have some image defect with a higher probability.

Furthermore, the respective tetrahedrons include a relatively large number of triangles as final interpolation spaces at the surfaces of the tetrahedrons and the interior thereof. This causes a proportional increase of the time and load required for an interpolation calculation. Furthermore, all of these triangles as interpolation spaces do not have the same shape. This causes another problem of a proportionally complicated interpolation calculation.

### SUMMARY OF THE INVENTION

An objective of the present invention is to provide an image processing apparatus and a table creation method which can reduce probability of an image defect due to the existence of a dividing surface in creating a table such as a color separation. Another objective of the present invention is to provide an image processing apparatus and a table creation method which can reduce the load and time required for an interpolation calculation.

In the first aspect of the present invention, there is provided an image processing apparatus that creates a table used for obtaining an output color signal corresponding to color signals which define three dimensional color space, said apparatus comprising: control line setting means for defining control lines on a cube, which is constituted of lattice points defined by the color signals, and determining lattice point data on the control lines; dividing means for dividing the tube at a cutting surface of a quadrangle defined in said cube into two triangular prisms which include the control lines as sides; interpolation means for, for each of the divided two triangular prisms, defining triangles, which include the control lines as sides, on surfaces of the triangular prism to determine lattice point data for the lattice point inside the respective triangles by performing interpolation calculation with use of lattice point data on the control lines as the sides, and defining triangles on an interior of the triangular prism to determine lattice point data for the lattice point inside the respective triangles by performing interpolation calculation with use of lattice point data on an interior of the triangles defined on the surfaces of the triangular prism; and synthesizing means for synthesizing the triangles, for which the lattice point data has been determined, to obtain the cube for which the lattice point data is defined.

In the second aspect of the present invention, there is provided a table creating method of creating a table used for obtaining an output color signal corresponding to color signals which define three dimensional color space, said method comprising: a control line setting step for defining control lines on a cube, which is constituted of lattice points defined by the color signals, and determining lattice point data on the control lines; a dividing step for dividing the tube at a cutting surface of a quadrangle defined in said cube into two triangular prisms which include the control lines as sides; an interpolation step for, for each of the divided two triangular prisms, defining triangles, which include the control lines as sides, on surfaces of the triangular prism to determine lattice point data for the lattice point inside the respective triangles by performing interpolation calculation with use of lattice point data on the control lines as the sides, and defining triangles on an interior of the triangular prism to determine lattice point data for the lattice point inside the respective triangles by performing interpolation calculation with use of lattice point data on an interior of the triangles defined on the surfaces of the triangular prism; and a synthesizing step for synthesizing the triangles, for which the lattice point data has been determined, to obtain the cube for which the lattice point data is defined.

According to the above-described configuration, in a table creation, firstly a cube constituting a table is divided into two triangular prisms. Then, in each of the triangular prisms, triangles at the surface of the triangular prism and an inner triangle in parallel with for example the upper surface and the bottom surface of the triangular prism are defined. Then, the respective triangles are assumed as interpolation spaces and lattice point data for lattice points in the triangles is determined. By this, a dividing surface caused when an interpolation spaces are defined from a cube is only one quadrangle that is a cut surface on the division. Thus, probability where lattice point data may be discontinuous at a dividing surface in the created table can be reduced. The number of the triangles at the surface and the interior of the triangular prism as the final interpolation spaces is relatively small. This can proportionally reduce the time and load required for the interpolation calculation. Furthermore, all of these triangles as interpolation spaces can have the same shape. This can proportionally simplify the interpolation calculation.

Thus, a table such as a color separation table can be created with a lower probability of occurring a false contour and the load and time required for the interpolation calculation can be reduced.

Further features of the present invention will become apparent from the following description of exemplary embodiments (with reference to the attached drawings).

### BRIEF DESCRIPTION OF THE DRAWINGS

FIG. 1 is a block diagram illustrating the structure for creating a color separation table according to the first embodiment of the present invention;

FIG. 2 is a view showing a computer system constituting one embodiment of an image processing apparatus of the present invention;

FIG. 3 is a block diagram illustrating the main part in the computer system shown in FIG. 2 mainly as a functional module;

FIG. 4 is a flowchart illustrating a processing for creating a color separation table according to the first embodiment of the present invention;

FIGS. 5A and 5B are diagrams showing a cube of LUT and control lines defined thereon according to one embodiment of the present invention, respectively;

FIGS. 6A and 6B are diagrams showing two triangular prisms formed by dividing a cube of LUT according to one embodiment of the present invention;

FIG. 7 is a diagram showing an example of an interpolation method for the interior of a triangle;

FIG. 8 is a block diagram illustrating the structure for creating a color separation table according to the second embodiment of the present invention; and

FIGS. 9A to 9F are diagrams showing six tetrahedrons obtained by dividing a cube according to one conventional example.

### DESCRIPTION OF THE EMBODIMENTS

Hereinafter, embodiments of the present invention will be described in detail with reference to the drawings.

### First Embodiment

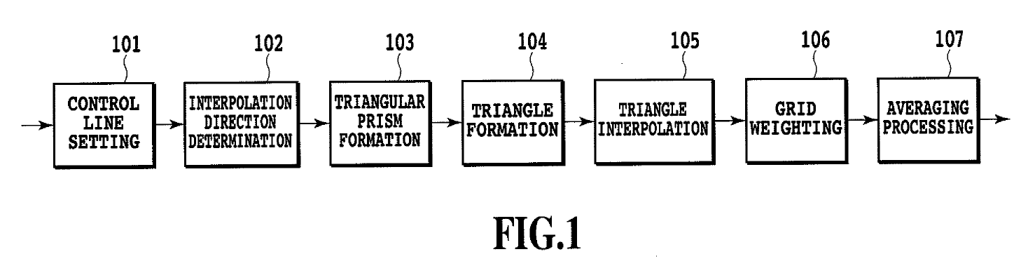

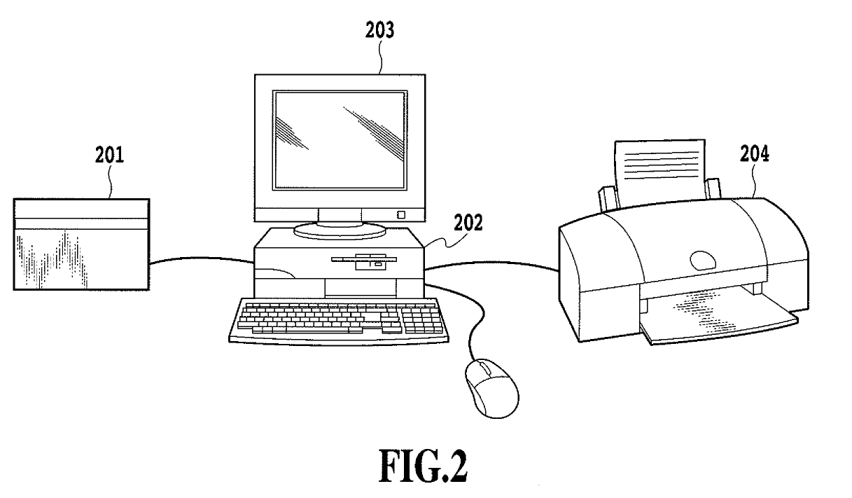

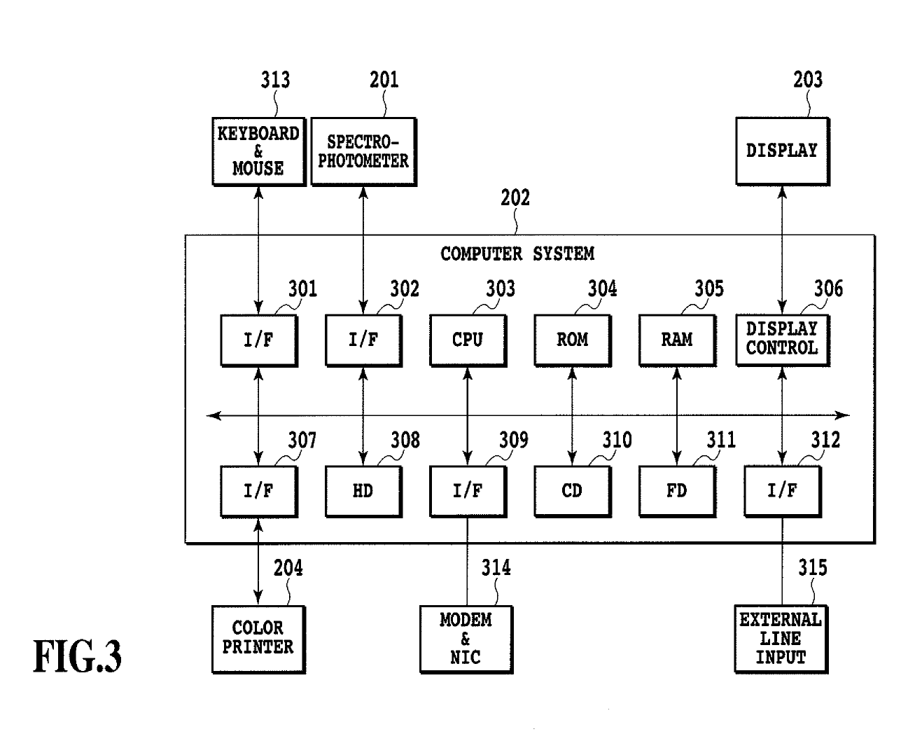

FIG. 1 is a block diagram illustrating the structure for creating a color separation table according to a first embodiment of the present invention. The structure shown in FIG. 1 specifically shows processing performed by a computer system, which will be described later with reference to FIG. 2 and FIG. 3. The color separation table of this embodiment makes colors (points) on a color space defined by R, G, and B color signals correspond to Y, M, C, and Bk output color signals for example.

As shown in FIG. 1, in creating a color separation table in the form of a lookup table (LUT) according to the first embodiment, firstly a control line setting 101 sets seven control lines on a cube composed of lattice points defined by R, G, and B signals. This setting process finally sets lattice point data for the respective lattice points on each of the seven control lines. Next, an interpolation direction determination 102 determines directions along which an interpolation is performed in the cube, that is, directions along which the division into triangular prisms is performed. Then, a triangular prism formation 103 cuts, in accordance with one of the above determined division directions, the cube at one cut surface including a diagonal line of one surface of the cube to define two triangular prisms. Further, a triangle formation 104 defines triangles at upper and lower surfaces and side surfaces of each of the two divided triangular prisms. Also, the triangle formation 104 defines triangles in the triangular prisms which are parallel to and are congruent with the upper and lower surfaces of the triangular prisms, in accordance with an interval of LUT lattice points. A triangle interpolation 105 assumes the respective triangles as interpolation spaces and uses the lattice point data of the control line to perform an interpolation calculation for determining lattice point data for lattice points in the triangles.

For the lattice point data determined by the interpolation in the respective three directions in a manner as described above, a grid weighting 106 performs weighting for each lattice point. Then, an averaging processing 107 averages the weighted lattice point data of the above three directions to obtain final lattice point data for LUT.

FIG. 2 is a view illustrating a computer system constituting one embodiment of the image processing apparatus of the present invention. In FIG. 2, a spectrophotometer 201 can read an image. The spectrophotometer 201 reads densities of patches in a color separation table creation and sends read signals to a personal computer 202. The personal computer 202 constituting the computer system receives an image signal read by the spectrophotometer 201 to edit and store the signal. The personal computer 202 also can allow the information by the obtained image signal to be displayed on a display 203 or to be printed out from a printer 204.

FIG. 3 is a block diagram showing the main part of the computer system shown in FIG. 2 mainly as a functional module.

In FIG. 3, a reference numeral 301 denotes an interface (I/F) that transmits an input and an output between a mouse and keyboard 313 for receiving various manual instructions from a user and the computer system 202. A reference numeral 302 denotes an interface (I/F) that transmits an input and an output between the computer system 202 and the spectrophotometer 201.

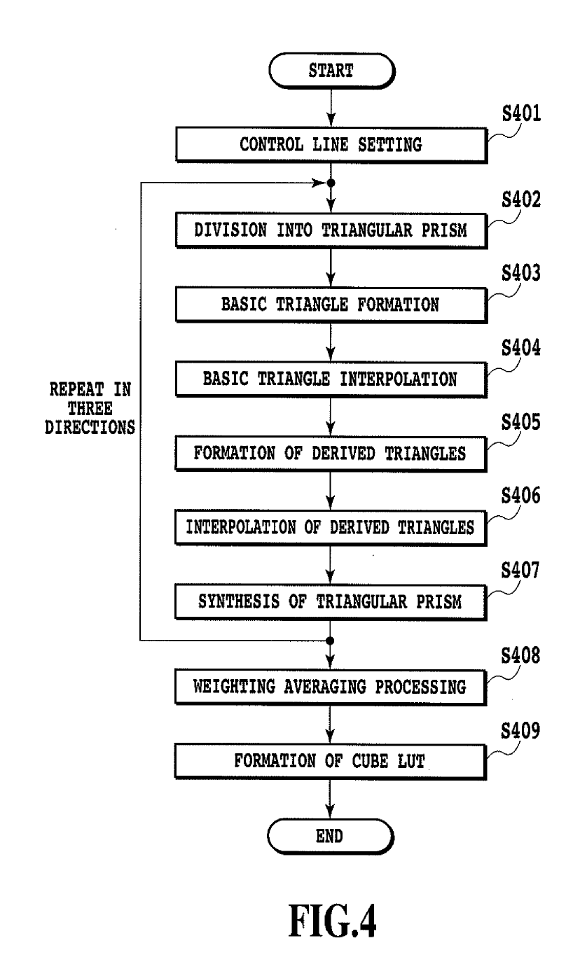

A reference numeral 303 denotes a CPU that executes, in accordance with a predetermined program, a control of operations of the respective components of the computer system and data processing. The CPU 303 executes, in accordance with a program, a color separation table creation process, which will be described later with reference to FIG. 4. A reference numeral 304 denotes a ROM that stores a program such as a program required for image processing. A reference numeral 305 denotes a RAM that temporarily stores, during the execution of a processing by the CPU 303, programs or processing data.

A reference numeral 306 denotes a display control device that controls the display device 203 which displays an image to be processed or a message to an operator. A reference numeral 307 denotes an interface (I/F) that transmits signals between the computer system 202 and the color printer 204. A reference numeral 308 denotes a hard disk (HD) that can previously store programs and image data which are to be transferred to the RAM 305 for example or that can store image data after the processing. A reference numeral 309 denotes an interface (I/F) connecting a computer system with the transmission device 314 such as a modem and a network card, which transmit various pieces of data maintained at the respective sections of the computer system to an external device or receives various pieces of data from an external device. A reference numeral 310 denotes a CD drive that reads or writes data from or to CD (CD-R, CD-RW, or DVD), which is one of external storage media. A reference numeral 311 denotes an FD drive that reads data from FD or writes data to FD as in the CD drive 310. When CD, FD, DVD or the like stores an image editing program or printer information for example, the information is installed in the HD 308 and is transferred to the RAM 305 when needed. A reference numeral 312 denotes a sound interface (I/F) that is connected with an external line input 315 or a microphone to receive audio data from the exterior.

FIG. 4 is a flowchart illustrating a color separation table creation process according to the first embodiment of the present invention. For this process, a program describing the procedure shown in the flowchart of FIG. 4 is stored in the ROM 304 or the external storage apparatus 308 and is loaded in the RAM 305 so that the CPU 303 can execute a processing based on this program.

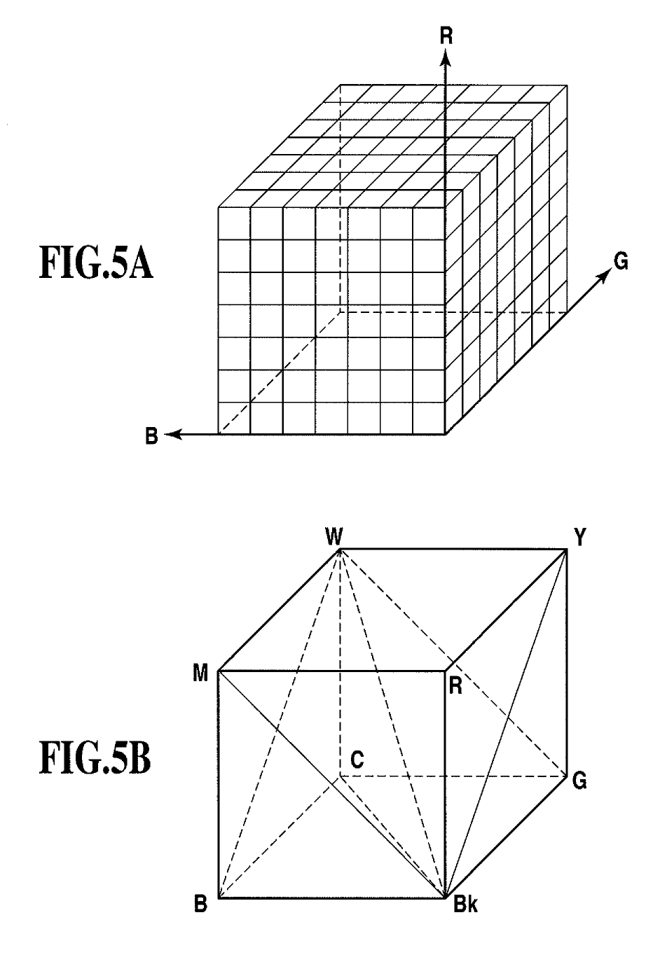

First, in step S401, for a cube defined by R, G, and B signals, as shown in FIG. 5A, a W-Bk line that connects a white lattice point (W) to a black lattice point (Bk) is set, as shown in FIG. 5B. Also W-C-Bk, W-M-Bk and W-Y-Bk lines are set, which connect lattice points corresponding to cyan (C), magenta (M) and yellow (Y) as the primary colors of color materials of a printer to lattice points (W) and (Bk) respectively. Further, W-R-Bk, W-G-Bk and W-B-Bk lines are set, which connect lattice points corresponding to red (R), green (G) and blue (B) as the secondary colors of color materials to latticepoints (W) and (Bk) respectively. Instep S401, further six additional control lines of Y-R, R-M, M-B, B-C, C-G, and G-Y are set, which connect the respective lattice points to each other. As described above, in step S401, the seven control lines and six additional control lines are set. Then, lattice point data is determined with regards to the respective control lines. First, patches corresponding to lattice points on these lines are printed by a printer and densities of the patches are read by the spectrometer 201. Based on the reading result, lattice point data (e.g., C, M, Y, K, Lc, Lm) corresponding to the respective lattice points (R, G, and B) is determined. A method used for determining the lattice point data may be any known method. The determined lattice point data for the lattice points on the control line as described above is stored in the external storage apparatus 308, the CD drive 310, or the FD drive 311. This data also can be obtained via the transmission device 314 such as a modem or network card, which can receive various pieces of data from an external device.

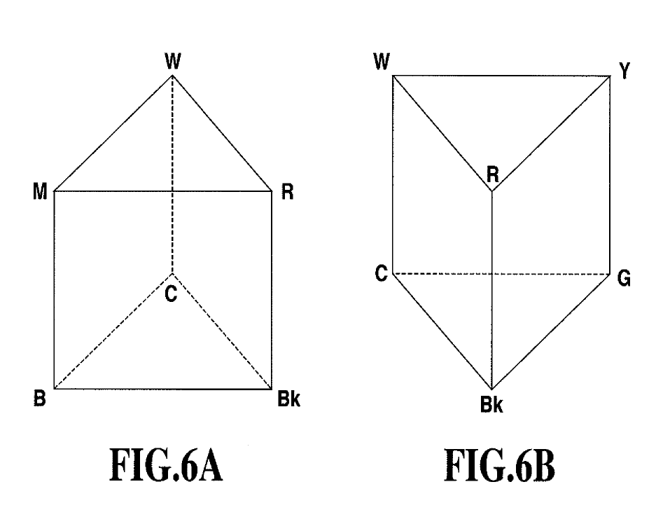

Next, in step S402, the cube shown in FIG. 5A is divided into two triangular prisms as shown in FIGS. 6A and 6B, which include, as a cutting surface, a quadrangle WRBkC having opposing sides that are diagonal lines of respective an upper surface WMRY and a bottom surface CBBkG of the cube.

It is noted that processes from the division step of step S402 to step 407 are repeated as the similar process for further respective two triangular prisms, which are different from the triangular prisms shown in FIGS. 6A and 6B in cutting surfaces at which the cube is divided into respective two triangular prisms. The cutting surfaces are a quadrangle WMBkG and a quadrangle WBBkY in FIG. 5B.

Next, in step S403, for each of two triangular prisms determined as described above, triangles are defined, which have control lines set in step S401 as three sides. For example, for a triangular prism shown in FIG. 6A, a triangle WMR (upper surface), a triangle CBBk (bottom surface), and triangles WCB, WMB, MBBk, MRBk, RBkC and RWC, which are defined on side surfaces of the triangular prism, are defined. The similar process is also performed for the triangular prism shown in FIG. 6B and data for an association between the coordinates of the respective formed triangles and inputted lattice point data is stored in the RAM 305. When the data volume is large, the data is stored in the external storage apparatus 308 for example.

Next, in step S404, for each of triangles of the two triangular prisms that are defined in step S403, interpolations are executed to determine lattice point data for the lattice points inside the triangle.

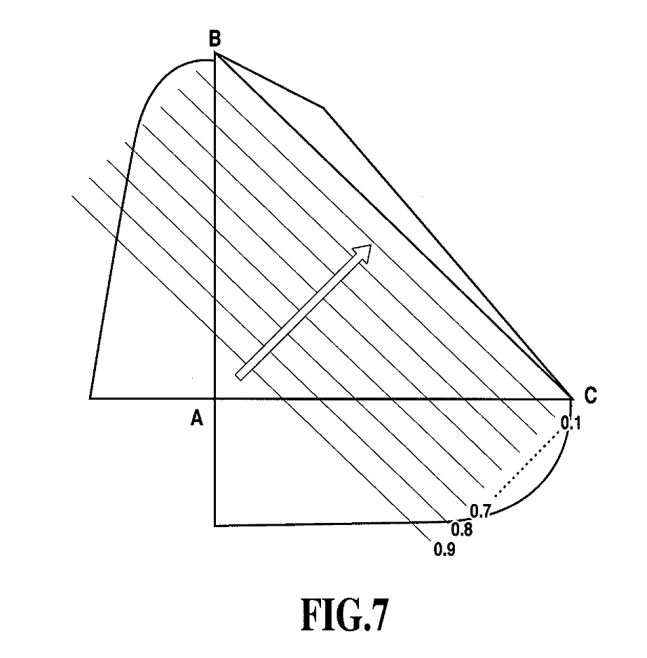

This interpolation for the interior of the triangle can use, for example, the method disclosed in Japanese Patent Application Laid-open No. 2002-033930 described above. However, the interpolation method is not particularly limited. For example, with regards to signal values of three sides of a triangle to be subjected to an interpolation, the interpolation may be performed, as shown in FIG. 7, in one direction, from a point connecting the side having largest signal value with the side having secondary large signal value, to the opposite side.

The interpolation method shown in FIG. 7 maybe used as follows. This method will be described briefly. In FIG. 7, when an interpolation is performed in a direction from a vertex A to a side BC, ink values (lattice point data) for the side AB and the side AC, and grid lines as straight lines that are parallel to the side BC and that pass the lattice points are used to determine ink values for the respective lattice points inside the triangle for the top A. Specifically, the ink value of a lattice point is calculated for the interpolation based on the ink values of respective intersection points of the grid line and the side AB and the side AC by using a ratio of an internal division derived from respective distances between the respective intersection points and the lattice point.

The lattice point data of the interior of the respective triangles calculated by the interpolation is stored in the RAM 305. When the data volume is large, the data is stored in the external storage apparatus 308 for example.

Next, in step S405, derived triangles are defined. In the case of the triangular prism shown in FIG. 6A, the derived triangles are defined, in the triangular prism, as triangles that are parallel to and congruent with the triangle WMR at the upper surface and the triangle CBBk at the bottom surface in accordance with an interval between LUT lattice points. This processing is also performed for the triangular prism shown in FIG. 6B, similarly. The coordinate data for the defined triangles is stored in the RAM 305. When the data volume is large, the data is stored in the external storage apparatus 308 for example.

Then, in step S406, the respective triangles of the respective triangular prisms defined in step S405 as interpolation spaces are subjected to an interpolation to determine lattice point data for the lattice points in the respective triangle. The interpolation method may be the same as the triangle interpolation in step S404. The lattice point data of the respective sides of the triangle used in this processing is lattice point data for the surface of the triangular prism determined by the interpolation calculation of step S404. The determined lattice point data for the interior of the respective triangles is stored in the RAM 305. When the data volume is large, the data is stored in the external storage apparatus 308 for example.

Next, in step S407, the lattice point data for the triangles of the respective triangular prisms processed in step S403 to step S406 is synthesized and finally two triangular prisms divided in step S402 are synthesized to provide an original cube.

The processes of steps 402 to 407 are performed a plurality of times. In this embodiment, the above processes are repeated for the three division directions as described for step 402. This finally provides cubes based on the lattice point data in accordance with the three division directions. These three types of pieces of LUT data for the cube are stored in the RAM305. When the data volume is large, the data is stored in the external storage apparatus 308 or the like.

In step S408, the three pieces of LUT data for the respective division directions stored in RAM 305 or the like are subjected to a weighting processing. Then, a processing is performed to obtain an average of the respective weighted pieces of lattice point data for the lattice points among the three pieces of LUT data. Specifically, an averaging control for a weighting among three (or a plurality of) cubes is performed. It is noted that the weighting may be performed, for example, so that parts (planes) sandwiching a gray axis (W-Bk line) are significantly weighted in accordance with a distance from the cutting surface for division into triangular prisms, or weightings are differentiated for respective hues.

Finally, in step S409, the lattice point data obtained by the average of the weighting in step S408 is used as final cube LUT data to store the data in the RAM 305, the external storage apparatus 308 or the like.

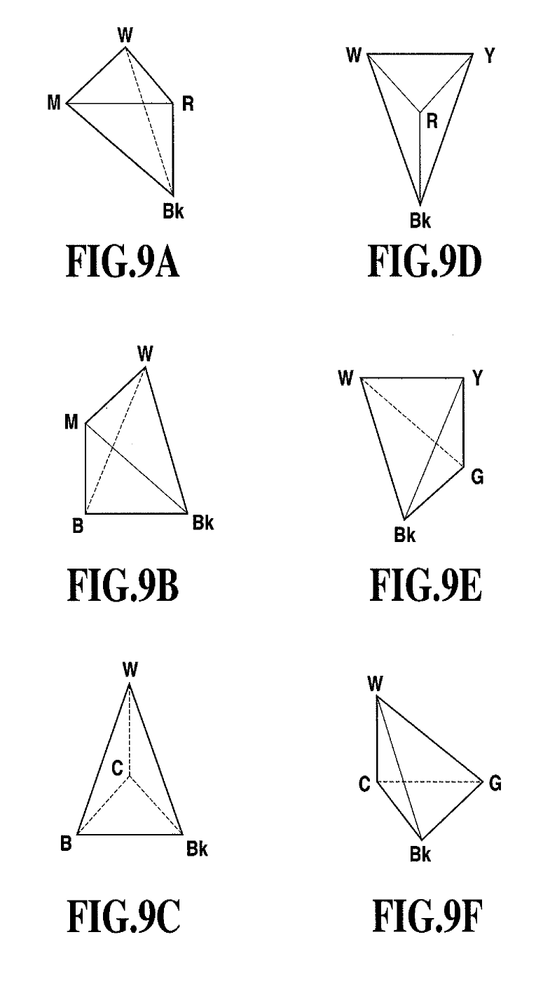

As described above, according to this embodiment, in an LUT creation, firstly a cube constituting a table is divided into two triangular prisms. Then, in each of the triangular prisms, triangles at the surface of the triangular prism and an inner triangle in parallel with for example the upper surface and the bottom surface of the triangular prism are defined. Then, the respective triangles are assumed as interpolation spaces and lattice point data for lattice points in the triangles is determined. By this, a dividing surface caused when an interpolation spaces are defined from a cube is, in the example shown in FIGS. 6A and 6B, only one quadrangle WCBkR that is a cut surface on the division. Thus, probability where lattice point data may be discontinuous at a dividing surface in the created table can be reduced. When compared with the conventional example shown in FIGS. 9A to 9F in particular, while the conventional example causes twelve dividing surfaces, this embodiment causes only one dividing surface. Thus, this embodiment can significantly reduce a probability where lattice point data may be discontinuous. As a result, a probability where a false contour is caused in a printed image can be reduced.

Also, in this embodiment, triangles as final interpolation spaces are defined on the surface and the interior of the triangular prism and thus a number of interpolation spaces is relatively small. As a result, the time and load required for the interpolation calculation can be proportionally reduced. Furthermore, since all of these triangles as interpolation spaces have the same shape. Thus, an interpolation calculation can be proportionally simplified.

### Second Embodiment

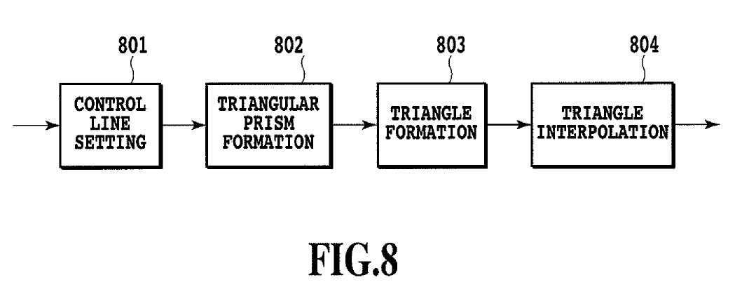

FIG. 8 is a block diagram illustrating a structure for creating a color separation table according to the second embodiment of the present invention. In this embodiment, a cube is divided only in one direction (i.e., only at one cutting surface). Thus, the structure shown in FIG. 8 is different from the structure shown in FIG. 1 according to the first embodiment in that the interpolation direction determination 102, the grid weighting 106, and the averaging processing 107 of the first embodiment are excluded.

### Third Embodiment

In the above-described first embodiment, one cube is set with seven control lines and six additional control lines. However, the present invention is not limited to this example. For example, only the seven control lines may be used for an interpolation with out using the additional control lines. In the case of a triangular prism shown in FIGS. 6A and 6B, additional control lines MR, RY, YG, GC, CB, and BM are not set. In this case, data of the lattice points on the line MR for example can be determined by a one-dimensional interpolation which uses the lattice point data of the lattice point M and the lattice point R. Data for lattice points on other additional control lines also can be similarly determined. Processes after the determination of the lattice point data of these lines are the same as that in the above embodiments.

### Another Embodiments

Although the above-described embodiments have described an example of a method for creating a color separation table, the present invention also can be applied to the creation of another table such as a color conversion table for color gamut conversion, as is clear from the above description.

### Still Another Embodiment

The present invention also can be realized by a program code realizing the procedure of the flowchart shown in FIG. 4 that realizes the function of the above-described embodiment or a medium storing therein such a program code. The present invention also can be achieved by allowing a computer of a system or an apparatus (or CPU or MPU) to read and execute a program code stored in a storage medium. In this case, the program code itself read from the storage medium realizes the above-described function of the embodiment and thus the storage medium storing therein the program code achieves the present invention.

Storage media for supplying a program code may be, for example, floppy (registered trademark) disk, hard disk, optical disk, magneto optical disk, CD-ROM, CD-R, magnetic tape, nonvolatile memory card, ROM or the like.

The above-described function of the embodiment is not limitedly realized by the execution of the program code read by a computer and also can be realized by an OS operating on the computer by allowing the OS to execute, based on the instruction of the program code, a part or the entirety of an actual processing.

Furthermore, another configuration also may be used in which a program code is written to a function enhancement board inserted to a computer or a memory in a function enhancement unit connected to a computer to subsequently allow, based on the instruction of the program code, CPU or the like to execute a part or the entirety of an actual processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-380065, filed Dec. 28, 2005, which is hereby incorporated by reference herein in its entirety.

What is claimed is:

1. An image processing apparatus that creates a table used for obtaining an output color signal corresponding to color signals which define three dimensional color space, said apparatus comprising:
control line setting means for defining control lines on a cube, which is constituted of lattice points defined by the color signals, and determining lattice point data on the control lines;
dividing means for dividing the tube at a cutting surface of a quadrangle defined in said cube into two triangular prisms which include the control lines as sides;
interpolation means for, for each of the divided two triangular prisms, defining triangles, which include the control lines as sides, on surfaces of the triangular prism to determine lattice point data for the lattice point inside the respective triangles by performing interpolation calculation with use of lattice point data on the control lines as the sides, and defining triangles on an interior of the triangular prism to determine lattice point data for the lattice point inside the respective triangles by performing interpolation calculation with use of lattice point data on an interior of the triangles defined on the surfaces of the triangular prism; and
synthesizing means for synthesizing the triangles, for which the lattice point data has been determined, to obtain the cube for which the lattice point data is defined.

2. An image processing apparatus as claimed in claim 1, further comprising an averaging control means for defining a plurality of the cutting surfaces which are different from each other to perform processes of dividing the cube by said dividing means, determining the lattice point data for the triangles by said interpolation, and obtaining the cube by said synthesizing means a plurality of times, performing weighting for lattice point data of the respective cube obtained by the plurality times of performing of the processes, and averaging the weighted lattice point data among the plurality of tubes to obtain the cube for which the lattice point data is defined.

3. An image processing apparatus as claimed in claim 2, wherein said averaging control means performs weighting so that planes sandwiching a gray axis in the cube are much more weighted in accordance with a distance from the cutting surface.

4. A table creating method of creating a table used for obtaining an output color signal corresponding to color signals which define three dimensional color space, said method comprising:
a control line setting step for defining control lines on a cube, which is constituted of lattice points defined by the color signals, and determining lattice point data on the control lines;
a dividing step for dividing the tube at a cutting surface of a quadrangle defined in said cube into two triangular prisms which include the control lines as sides;
an interpolation step for, for each of the divided two triangular prisms, defining triangles, which include the control lines as sides, on surfaces of the triangular prism to determine lattice point data for the lattice point inside the respective triangles by performing interpolation calculation with use of lattice point data on the control lines as the sides, and defining triangles on an interior of the triangular prism to determine lattice point data for the lattice point inside the respective triangles by performing interpolation calculation with use of lattice point data on an interior of the triangles defined on the surfaces of the triangular prism; and
a synthesizing step for synthesizing the triangles, for which the lattice point data has been determined, to obtain the cube for which the lattice point data is defined.

5. A table creating method as claimed in claim 4, further comprising an averaging control step for defining a plurality of the cutting surfaces which are different from each other to perform processes of dividing the cube by said dividing step, determining the lattice point data for the triangles by said interpolation, and obtaining the cube by said synthesizing step a plurality of times, performing weighting for lattice point data of the respective cube obtained by the plurality times of performing of the processes, and averaging the weighted lattice point data among the plurality of tubes to obtain the cube for which the lattice point data is defined.

6. A table creating method as claimed in claim 5, wherein said averaging control step performs weighting so that planes sandwiching a gray axis in the cube are much more weighted in accordance with a distance from the cutting surface.

7. A program that is loaded in a computer to cause the computer to function as an image processing apparatus that creates a table used for obtaining an output color signal corresponding to color signals which define three dimensional color space,
wherein the image processing apparatus comprising:
control line setting means for defining control lines on a cube, which is constituted of lattice points defined by the color signals, and determining lattice point data on the control lines;
dividing means for dividing the tube at a cutting surface of a quadrangle defined in said cube into two triangular prisms which include the control lines as sides;
interpolation means for, for each of the divided two triangular prisms, defining triangles, which include the control lines as sides, on surfaces of the triangular prism to determine lattice point data for the lattice point inside the respective triangles by performing interpolation calculation with use of lattice point data on the control lines as the sides, and defining triangles on an interior of the triangular prism to determine lattice point data for the lattice point inside the respective triangles by performing interpolation calculation with use of lattice point data on an interior of the triangles defined on the surfaces of the triangular prism; and
synthesizing means for synthesizing the triangles, for which the lattice point data has been determined, to obtain the cube for which the lattice point data is defined.

8. A storage medium storing a program that is loaded in a computer to cause the computer to function as an image processing apparatus that creates a table used for obtaining an output color signal corresponding to color signals which define three dimensional color space,
wherein the image processing apparatus comprising:
control line setting means for defining control lines on a cube, which is constituted of lattice points defined by the color signals, and determining lattice point data on the control lines;
dividing means for dividing the tube at a cutting surface of a quadrangle defined in said cube into two triangular prisms which include the control lines as sides;
interpolation means for, for each of the divided two triangular prisms, defining triangles, which include the control lines as sides, on surfaces of the triangular prism to determine lattice point data for the lattice point inside the respective triangles by performing interpolation calculation with use of lattice point data on the control lines as the sides, and defining triangles on an interior of the triangular prism to determine lattice point data for the lattice point inside the respective triangles by performing interpolation calculation with use of lattice point data on an interior of the triangles defined on the surfaces of the triangular prism; and
synthesizing means for synthesizing the triangles, for which the lattice point data has been determined, to obtain the cube for which the lattice point data is defined.
